(19) United States
(12) Patent Application Publication
(10) Pub. No.: US 2013/0106925 A1
(43) Pub. Date: May 2, 2013

(54) LIQUID CRYSTAL CONTROL DEVICE, LIQUID CRYSTAL PANEL DRIVING DEVICE, LIQUID CRYSTAL DISPLAY DEVICE AND METHOD OF DRIVING LIQUID CRYSTAL PANEL

(71) Applicant: Takashi Sasaki, Osaka-shi (JP)

(72) Inventor: Takashi Sasaki, Osaka-shi (JP)

(73) Assignee: SHARP KABUSHIKI KAISHA, Osaka-shi, Osaka (JP)

(21) Appl. No.: 13/808,149

(22) PCT Filed: Jun. 3, 2011
(86) PCT No.: PCT/JP2011/062766

§ 371 Date: Jan. 3, 2013

(30) Foreign Application Priority Data
Jul. 9, 2010 (JP) 2010-156931

(51) Int. Cl. G02F 1/133

(52) U.S. Cl. CPC G02F 1/13306
USPC 345/690; 349/37; 345/89

(57) ABSTRACT

A liquid crystal display device includes a grayscale signal generator, a voltage generator, and a liquid crystal driver. The grayscale signal generator receives an image signal and generates separate positive and negative grayscale signals according to characteristics of a liquid crystal panel. The positive grayscale signal and the negative grayscale signal are for driving with positive polarity and negative polarity, respectively. The voltage generator generates the maximum voltage and the minimum voltage for the driving with positive polarity and the maximum voltage and the minimum voltage for the driving with negative polarity. The liquid crystal driver generates a positive grayscale voltage corresponding to the positive grayscale signal using a resistance voltage divider circuit, the maximum voltage, and the minimum voltage. The liquid crystal driver generates a negative grayscale voltage corresponding to the negative grayscale signal using a resistance voltage divider circuit, the maximum voltage, and the minimum voltage.

### TECHNICAL FIELD

The present invention relates to technologies for generating grayscale voltages by a liquid crystal driver for alternately driving a liquid crystal panel with positive and negative polarities.

### BACKGROUND ART

During driving of a liquid crystal panel, the liquid crystal panel is usually alternately driven with positive and negative polarities to reduce degradation of liquid crystals. An example of generating grayscale voltages for grayscale display while alternately driving the liquid crystal panel with positive and negative polarities is disclosed in Patent Document 1. Patent Document 1 discloses a technology for generating multiple reference voltages by dividing a voltage by ladder resistors to generate multiple levels of grayscale voltages corresponding to grayscale numbers (gray levels). Furthermore, variable resistors and various kinds of registers are provided for reference voltage adjustment. The reference voltages are adjusted to set the grayscale voltages corresponding to the gray levels appropriate for the liquid crystal panel. The resistors include a slope adjustment resister and a tap adjustment resistor.

### RELATED ART DOCUMENT

### Patent Document

Patent Document 1: Japanese Unexamined Patent Application Publication No. 2009-8958

### Problem to be Solved by the Invention

According to the technology disclosed in Patent Document 1, the grayscale voltage levels can be adjusted appropriately for the liquid crystal panel. However, the variable resistors and the various kinds of registers are required. Therefore, a technology for adjusting grayscale voltage levels appropriately for different liquid crystal panels with simple configurations is needed.

### DISCLOSURE OF THE PRESENT INVENTION

The present invention was made in view of the foregoing circumstances. An object of the present invention is to provide a technology for simplifying a configuration for generating grayscale voltages appropriately for different liquid crystal panels.

### Means for Solving the Problem

To solve the problem described earlier, a liquid crystal control device according to the present invention may include a grayscale signal generator and a voltage generator. The liquid crystal control device is configured to alternately drive a liquid crystal panel with positive polarity and with negative polarity through a liquid crystal driver. The liquid crystal driver includes a resistance voltage divider circuit for generating multiple grayscale voltages. The grayscale signal generator is configured to: receive an image signal containing grayscale data; generate a positive grayscale signal and a negative grayscale signal separately from each other according to characteristics of the liquid crystal panel; and supply the positive grayscale signal and the negative grayscale signal to the liquid crystal driver. The positive grayscale signal is for driving the liquid crystal panel with positive polarity. The negative gray scale signal is for driving the liquid crystal panel with negative polarity. The voltage generator is configured to: generate positive maximum and minimum voltages for generating grayscale voltages for driving the liquid crystal panel with positive polarity, according to the positive grayscale signal; generate negative maximum and minimum voltages for generating grayscale voltages for driving the liquid crystal panel with negative polarity, according to the negative grayscale signal; and apply the generated voltages to the liquid crystal driver.

A liquid crystal panel device according to the present invention may be configured to alternately drive a liquid crystal panel with positive polarity and with negative polarity, and may include a grayscale signal generator, a voltage generator, and a liquid crystal driver. The grayscale signal generator is configured to: receive an image signal containing grayscale data; and generate a positive grayscale signal and a negative grayscale signal separately from each other according to characteristics of the liquid crystal panel. The positive grayscale signal is for driving the liquid crystal panel with positive polarity. The negative grayscale signal is for driving the liquid crystal panel with negative polarity. The voltage generator is configured to: generate maximum and minimum voltages for driving the liquid crystal panel with positive polarity; and generate maximum and minimum voltages for driving the liquid crystal panel with negative polarity. The liquid crystal driver includes a resistance voltage divider circuit. The liquid crystal driver is configured to: generate a positive grayscale voltage corresponding to the positive grayscale signal using the resistance voltage divider circuit and the maximum voltage and the minimum voltage for driving the liquid crystal panel with positive polarity; generate a negative grayscale voltage corresponding to the negative grayscale signal using the resistance voltage divider circuit and the maximum voltage and the minimum voltage for driving the liquid crystal panel with negative polarity; and alternately apply the positive grayscale voltage and the negative grayscale voltage every predetermined period.

A liquid crystal panel driving method according to the present invention is to drive a liquid crystal panel with positive polarity and negative polarity through a liquid crystal driver including a resistance voltage divider circuit for generating multiple grayscale voltages. The method may include a grayscale signal supplying process, a generated voltage applying process, and a grayscale voltage generating process. The grayscale signal supplying process may include: receiving an image signal containing grayscale data; generating a positive grayscale signal and a negative grayscale signal separately from each other according to characteristics of the liquid crystal panel; and supplying the positive grayscale signal and the negative grayscale signal to the liquid crystal driver. The positive grayscale signal is for driving the liquid crystal panel with positive polarity. The negative grayscale signal is for driving the liquid crystal panel with negative polarity. The generated voltage applying process may include: generating positive maximum and minimum voltages for generating grayscale voltages for driving the liquid crystal panel with positive polarity, according to the positive grayscale signal; generating negative maximum and minimum voltages for generating grayscale voltages for driving the liquid crystal panel with negative polarity, according to the negative grayscale signal; and applying the generated voltages to the liquid crystal driver. The grayscale voltage generating process may include generating grayscale voltages to drive the liquid crystal panel with positive polarity by the liquid crystal driver using the resistance voltage divider circuit, the positive maximum voltage, and the positive minimum voltage; and generating grayscale voltages to drive the liquid crystal panel with negative polarity by the liquid crystal driver using the resistance voltage divider circuit, the negative maximum voltage, and the negative minimum voltage.

With the above configurations, only four kinds of reference voltages are applied to the liquid crystal driver for generating the grayscale voltages to drive the liquid crystal panel with positive polarity and the grayscale voltages to drive the liquid crystal panel with negative polarity. The four kinds of reference voltages include the positive maximum voltage, the positive minimum voltage, the negative maximum voltage, and the negative minimum voltage. The grayscale voltages to drive the liquid crystal panel with positive and negative polarities at multiple gray levels are generated using the four different voltages and the resistance voltage divider circuit of the liquid crystal driver. The grayscale voltages are generated according to the characteristics of the liquid crystal panel, such as the gamma characteristics. For example, the grayscale voltages are generated to correct the gamma characteristics. To drive the liquid crystal panel with positive and negative polarities at multiple gray levels, a gray-level DAC for generating grayscale voltages according to the gamma characteristics is not required. Furthermore, grayscale voltages are not applied to the liquid crystal panel by a liquid crystal control board. Therefore, the number of connector pins can be reduced and the configuration for generating the grayscale voltages appropriately for different crystal panels can be simplified.

The term “positive polarity” refers to a voltage higher than the center voltage in the driving of the liquid crystal panel with positive and negative polarities. The term “negative polarity” refers to a voltage lower than the center voltage. Namely, the positive polarity and the negative polarity do not correspond to actual polarities of voltages.

The liquid crystal control device may include a positive lookup table and a negative lookup table. The positive lookup table may be configured to store positive grayscale data for generating the positive grayscale signal corresponding to the grayscale data. The negative lookup table may be configured to store negative grayscale data for generating the negative grayscale signal corresponding to the grayscale data. The grayscale signal generator may be configured to generate the positive grayscale signal and the negative grayscale signal using the positive lookup table an the negative lookup table.

With this configuration, the grayscale signals corresponding to the input grayscale data can be generated by only referring to the lookup tables.

The positive lookup table and the negative lookup table may store positive grayscale data and negative grayscale data, respectively. The positive grayscale data and the negative grayscale data may be prepared according to panel characteristics of the liquid crystal panel. With this configuration, the grayscale signals to correct the panel characteristics including the gamma characteristics can be easily generated.

The liquid crystal control device may include an electrically rewritable memory. The positive lookup table and the negative lookup table may be stored in the memory. With this configuration, the positive lookup table and the negative lookup table can be modified appropriately for different liquid crystal panels. Namely, the liquid control board (or the liquid control device) can be configured appropriately for different liquid crystal panels. The grayscale voltages can be generated appropriately for different liquid crystal panels only by modifying the lookup tables.

The voltage generator may be configured to generate the minimum voltage of the positive grayscale voltages and the maximum voltage of the negative grayscale voltages at the same voltage level. The liquid crystal panel may include a common electrode for driving the liquid crystals, and the voltage generator may be configured to generate a common electrode voltage applied to the common electrode of the liquid crystal panel. The voltage generator may be further configured to generate the minimum voltage of the positive grayscale voltages and the maximum voltage of the negative grayscale voltages at the same voltage level as the common electrode voltage. With this configuration, the kinds of the voltages that the voltage generator generates are reduced. Therefore, a degree of complexity in configuration of the voltage generator can be reduced and the number of lines between the voltage generator and the liquid crystal driver can be further reduced.

A liquid crystal display device according to the present invention may include a liquid crystal panel and the above liquid crystal panel driving device.

### Advantageous Effect of the Invention

According to the present invention, the configuration for generating grayscale voltages appropriately for different liquid crystal panels can be simplified.

### BRIEF DESCRIPTION OF THE DRAWINGS

FIG. 1 is a block diagram illustrating a general configuration of a liquid crystal display device according to an embodiment of the present invention.

FIG. 2 is a block diagram illustrating a general configuration of a source driver in the liquid crystal display device.

FIG. 3 is a block diagram illustrating a general configuration of a timing controller in the liquid crystal display device.

FIG. 4 is a lookup table containing grayscale data.

FIG. 5 is a graph illustrating relationships between gray levels and grayscale voltages during alternate driving.

FIG. 6 is a graph illustrating relationships between grayscale levels and grayscale voltages during alternate driving in another example.

### MODE FOR CARRYING OUT THE INVENTION

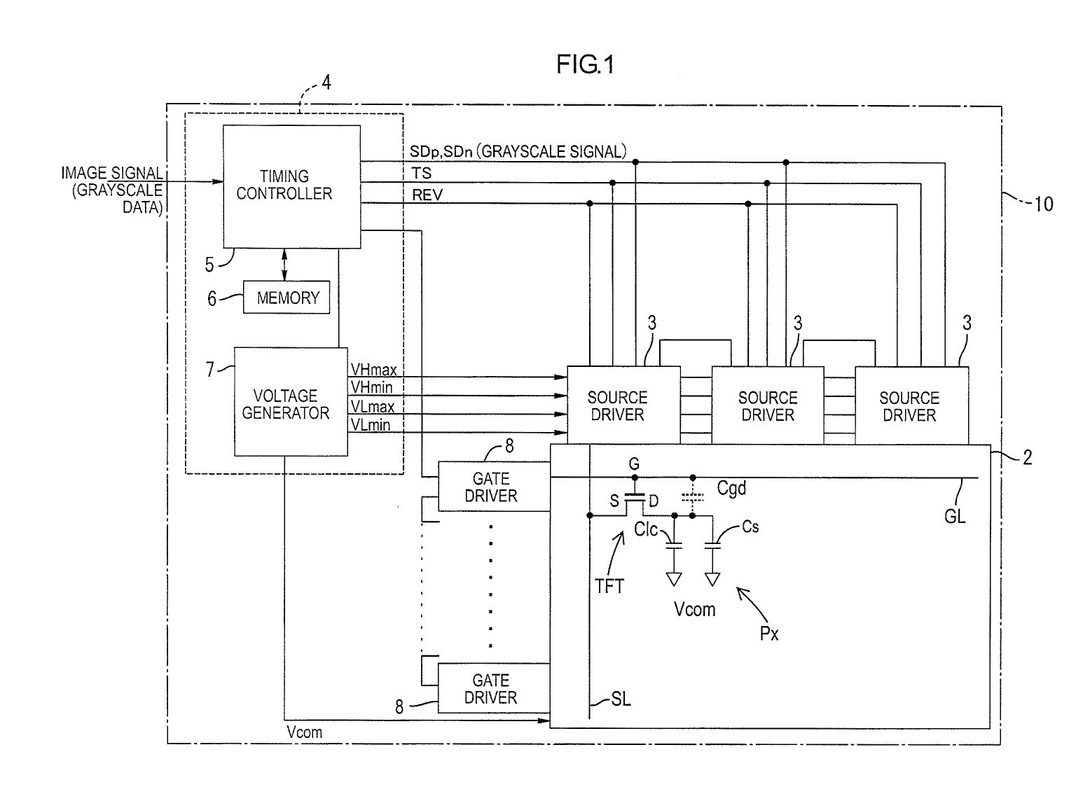

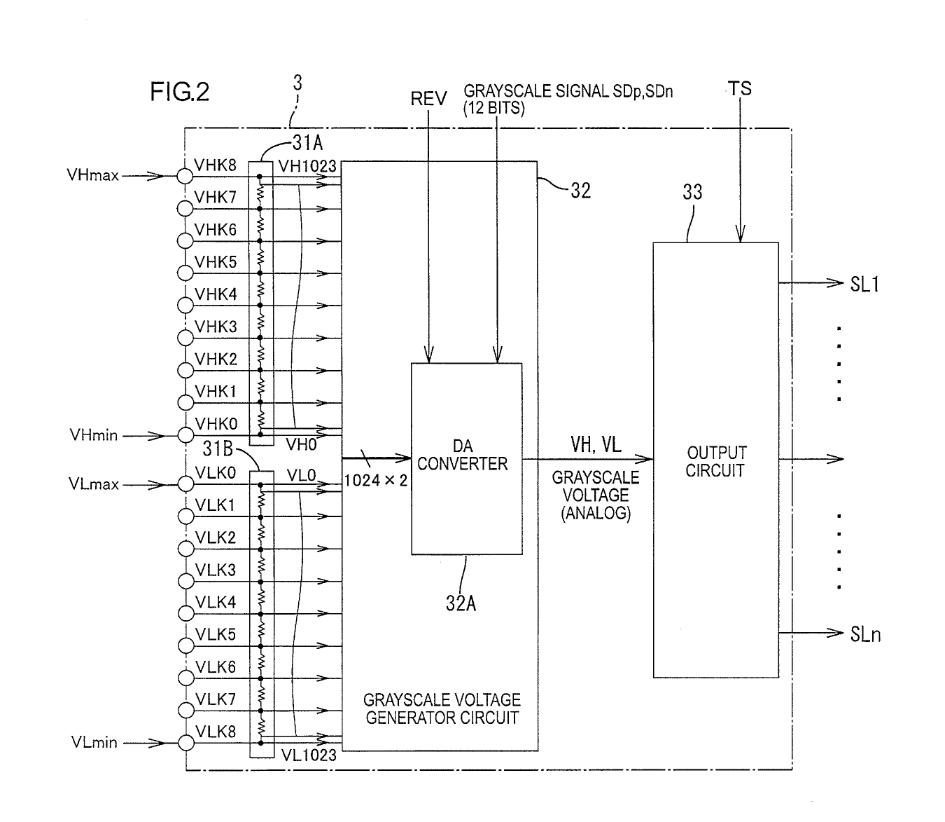

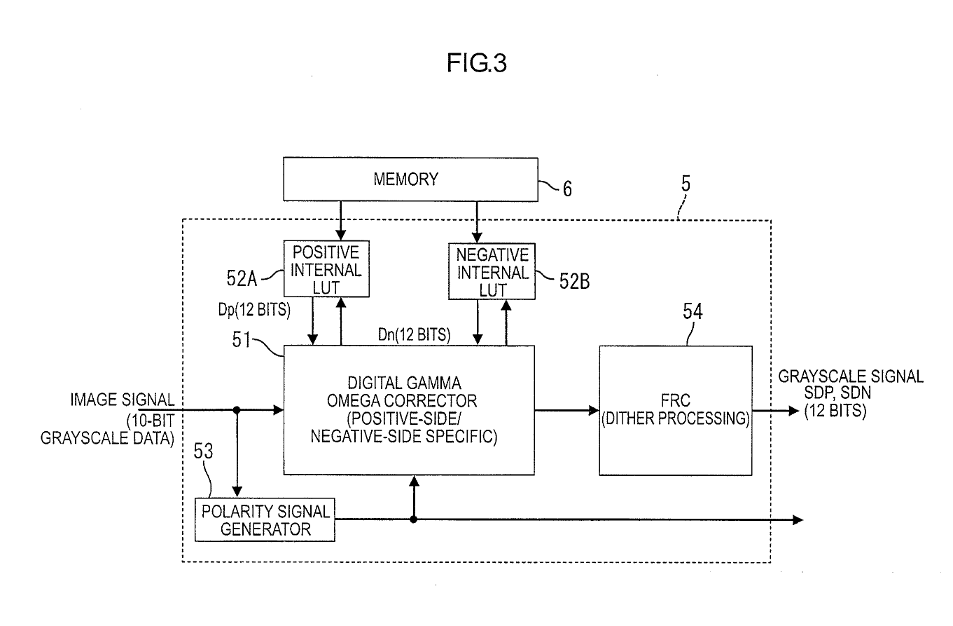

An embodiment of the present invention will be explained with reference to FIGS. 1 to 5. FIG. 1 is a block diagram illustrating a general configuration of a liquid crystal display device 10 according to this embodiment of the present invention. FIG. 2 is a block diagram illustrating a general configuration of a source driver 3 in the liquid crystal display device 10. FIG. 3 is a block diagram illustrating a general configuration of a timing controller 5 in the liquid crystal display device 10.

As illustrated in FIG. 1, the liquid crystal display device 10 includes a liquid crystal panel 2, a plurality of source drivers 3, a liquid crystal control unit 4, and a plurality of gate drivers 8. The liquid crystal control unit 4 includes a backlight (not illustrated) and other components. In FIG. 1, the source drivers 3 and the gate drivers 8 are connected by tape automated bonding (TAB). However, the connecting method is not limited to the TAB. For example, a chip on glass (COG) method may be used. The liquid crystal control unit 4 and the source drivers 3 may correspond to a liquid crystal panel driving device of the claimed invention.

The liquid crystal panel 2 includes two glass substrates (not illustrated). The liquid crystal panel 2 is a known active matrix liquid crystal panel alternately driven with positive and negative polarities. However, the liquid crystal panel is not limited to the active matrix liquid crystal panel.

As illustrated in FIG. 1, pixels Px are provided on the glass substrate on which active components are arranged at respective intersections between source lines SL and gate lines GL. Each pixel includes a thin film transistor FTF, a liquid crystal layer Clc, and an auxiliary capacitor Cs. Furthermore, a parasitic capacitance Cgd appears between the gate line GL and a drain electrode of the thin film transistor FTF. The parasitic capacitance Cgd affects an LCD driving voltage (a grayscale voltage) applied to the liquid crystal layer Clc of each pixel Px, which results in variations in the LCD driving voltage.

A common electrode (not illustrated) is provided on the other glass substrate. A common electrode voltage Vcom is applied to the common electrode. The liquid crystal panel 2 is alternately driven with positive and negative polarities relative to the common electrode voltage Vcom. At this time, an AC voltage, a polarity of which alters at predetermined intervals, e.g., frame-period intervals, is applied to each pixel Px. As a result, deterioration of the liquid crystal layer Clc is reduced.

In the description of this embodiment, “positive polarity” and “negative polarity” are determined as follows. If a voltage is higher than common electrode voltage Vcom (a center voltage during the alternate driving), the voltage has a “positive polarity.” If a voltage is lower than the common electrode voltage Vcom, the voltage has a “negative polarity.” Namely, the “positive polarity” and the “negative polarity” do not correspond to actual polarities of the voltages. The common electrode voltage Vcom can be set at any level, for instance, at a positive 5V, a ground voltage (i.e., 0V), or a negative 5V. If the common electrode voltage Vcom is set to +5V, a positive driving voltage VH (the grayscale voltage) for driving with positive polarity and a negative driving voltage VL (the grayscale voltage) for driving with negative polarity are both positive voltages. If the common electrode voltage is set to 0V, the positive driving voltage VH is a positive voltage and the negative driving voltage VL is a negative voltage.

As illustrated in FIG. 2, each source driver 3 (corresponding to a liquid crystal driver according to the claimed invention) includes positive reference voltage input terminals (VMK0-VMK8), negative reference voltage input terminals (VLK0-VLK8), a positive ladder resistor 31A (a resistance voltage divider circuit), a negative ladder resistor 31B (a resistance voltage divider circuit), a grayscale voltage generator circuit 32, and an output circuit 33. The positive ladder resistor 31A includes a plurality of resistors connected in series to generate the positive grayscale voltages VH. The negative ladder resistor 31B includes a plurality of resistors connected in series to generate the negative gray scale voltages HL. The source driver 3 has a known source driver configuration to receive a plurality of references and to generate gray scale voltages.

In this embodiment, the source driver 3 receives the maximum voltage VHmax among the positive grayscale voltages VH, the minimum voltage VHmin among the positive grayscale voltages VH, the maximum voltage HLmax among the negative grayscale voltages VL, and the minimum voltage VLmin among the negative grayscale voltages VL from the liquid crystal control unit 4 through the input terminal VMK8, VMK0, VLK0, and VLK8, respectively. In this embodiment, no reference voltages are input through the positive reference voltage input terminals (VMK1-VMK7) and the negative reference voltage input terminals (VLK1-VLK7). Namely, the input terminals (VMK1-VMK7, VLK1-VLK7) are not used. The source driver 3 also receives a positive grayscale signal SDp (a display data signal), a negative grayscale signal SDn (a display data signal), a polarity inversion signal REV, and a timing signal Ts. Then, the source driver 3 generates a positive grayscale voltage VH (an analog voltage) corresponding to the positive grayscale signal SDp using the positive ladder resistor 31A, the maximum voltage VHmax, and the minimum voltage VHmin. Furthermore, the source driver 3 generates a negative grayscale voltage VL (an analog voltage) corresponding to the negative grayscale signal SDn using the negative ladder resistor 31B, the maximum voltage VLmax, and the minimum voltage VLmin.

More specifically, the positive ladder resistor 31A includes 1,023 resistors. A voltage difference between the maximum voltage VHmax and the minimum voltage VHmin is divided by the resistors to generate 1,024 levels of positive grayscale voltages (VH0-VH1023).

Similarly, the negative ladder resistor 31B includes 1,023 resistors. A voltage difference between the maximum voltage VLmax and the minimum voltage VLmin is divided by the resistors to generate 1,024 levels of negative grayscale voltages (VL0-VL1023). The positive grayscale voltages (VH0-VH1023) and the negative grayscale voltages (VL0-VL1023) are applied to the grayscale voltage generator circuit 32.

The divided voltages by the positive ladder resistor 31A and the negative ladder resistor 31B, that is, the grayscale voltages are determined based on configurations of the ladder resistors. If resistors in the ladder resistors have the same resistance, differences in voltage among the divided voltages (i.e., the grayscale voltages) are equal. Differences in resistance can be set at different levels according to regions of the grayscale levels by setting the resistances of the resistors at different levels. Namely, the relationships between the gray levels (0 to 1,023) and the grayscale voltages (VH0 to VH1023, VL0 to VL1023) are determined based on the configurations of the ladder resistances (31A, 31B) of the currently used source driver.

The grayscale voltage generation circuit 32 includes a DA converter 32A. The DA converter 32A receives 2,048 kinds (or levels) of grayscale voltages, polarity inversion signals REV and grayscale signals SDp and SDn. The 2,048 kinds of grayscale voltages include the positive grayscale voltages (VH0 to VH1023) and the negative grayscale voltages (VL0 to VL1023). The DA converter 32A selects the grayscale voltages (analog voltages) VH and VL corresponding to the pixel Px from the 2,048 levels of the grayscale voltages based on the polarity inversion signal REV and the grayscale signals SDp and SDn. Then, the DA converter 32A applies the grayscale voltages VH and VL to an output circuit 33.

The output circuit 33 latches the grayscale voltages for the specified number of pixels n (the specified number of the source lines n). The output circuit 33 alternately outputs the positive grayscale voltages VH and the negative grayscale voltages VL at predetermined timing and at the same timing for the specified number of the source lines (SL1 to SLn). With this configuration, the pixels Px are alternately driven with positive and negative polarities.

The configuration for generating the grayscale voltages (VH, VL) by the source driver is not limited to the above configuration. For instance, the grayscale voltages may be 256 levels, or predetermined levels of grayscale voltages may be generated by resistance voltage divider circuit (ladder resistors) and other configuration. Namely, any method can be used to generate the grayscale voltages corresponding to the predetermined grayscale levels based on the reference voltages and the resistance voltage divider circuit. Any method can be used as long as the source driver that is configured to generate driver-specific predetermined number of the grayscale voltages independently from the liquid crystal panel 2 based on the reference voltages and the resistance voltage divider circuit is used.

The liquid crystal control unit 4 includes a timing controller 5, a memory 6, and a voltage generator 7. The memory includes a ROM, an EEPROM (electronically erasable and programmable read only memory), and a RAM.

The voltage generator 7 is configured to generate various voltages including a common electrode voltage Vcom, maximum voltages VHmax and VLmax, and minimum voltages VHmin and VLmin. The common electrode voltage Vcom is applied to the common electrode of the liquid crystal panel 2. The maximum voltages VHmax and VLmax and the minimum voltages VHmin and VLmin are applied to the source driver 3.

As illustrated in FIG. 3, the timing controller 5 (corresponding to a grayscale signal generator according to the claimed invention) includes a digital gamma omega corrector 51, a positive (+) internal LUT (lookup table) 52A, a negative (−) internal LUT 52B, a polarity signal generator 53, and a dither processor 54. The timing controller 5 may be configured by ASIC (application specific integrated circuits).

The polarity signal generator 53 is configured to generate polarity inversion signals REV for alternately driving the liquid crystal panel with positive and negative polarities per predetermined period, for instance, frame period. The polarity signal generator 53 is further configured to send the polarity inversion signals REV to the digital gamma omega corrector 51 and the source drivers 3. The predetermined period of the polarity inversion is not limited to the frame period. The predetermined period may be a period for inverting the polarity every unit of pixels Px in line (i.e., per line) or every pixel Px (i.e., per pixel).

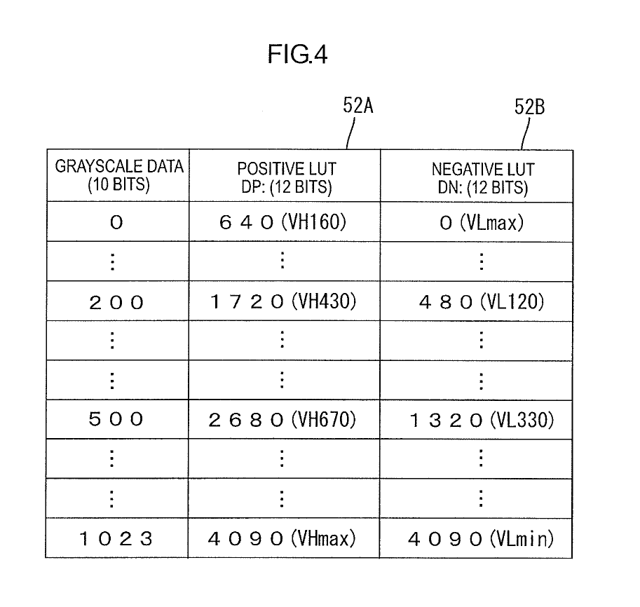

As illustrated in FIG. 4, the positive internal LUT 52A contains 12-bit positive grayscale data Dp for 10-bit grayscale data (input grayscale data) included in image signals. The negative internal LUT 52B contains 12-bit negative grayscale data Dn for 10-bit input grayscale data. Specifically, the positive internal LUT 52A and the negative internal LUT 52B contain 1,024 kinds of the positive grayscale data Dp and 1,024 kinds of the negative gray scale data Dn, respectively, for 1,024 kinds of the input grayscale data (10 bits). The configuration of grayscale data bits can be altered as appropriate. For example, the positive grayscale data Dp and the negative grayscale data Dn for 8-bit input grayscale data maybe 8-bit data or 10-bit data.

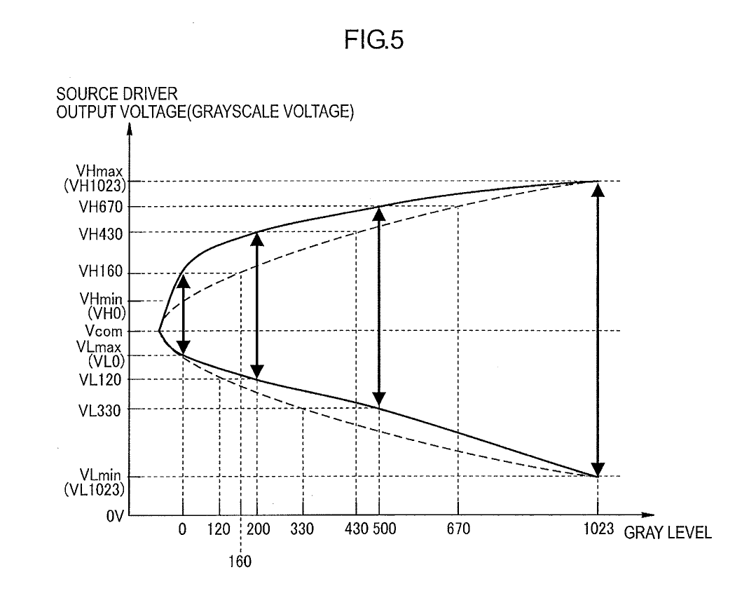

As illustrated in FIG. 4, 1,024 kinds of the positive grayscale data Dp correspond to 1,024 kinds of the positive grayscale voltages (VHmin (VH0) to Vmax (VH1023)). 1,024 kinds of the negative grayscale data Dn correspond to 1,024 kinds of the negative scale voltages (VLmin (VL0 to VLmax (VL1023)). The 12-bit grayscale data Dp and Dn correspond to the respective voltage levels of the gray scale voltages (analog voltages). As illustrated in FIG. 4, the positive grayscale data Dp corresponding to the input grayscale data “200” is set to “1720” and the negative grayscale data Dn corresponding to the input grayscale data “200” is set to “480.” The voltage difference between the positive grayscale data VH430 corresponding to the positive grayscale data “1720” and the common electrode voltage Vcom is different from the voltage difference between the negative grayscale voltage VL120 corresponding to the negative grayscale data “480” and the common electrode voltage Vcom (see FIG. 5).

The positive internal LUT 52A and the negative internal LUT 52B contain the positive grayscale data Dp and the negative grayscale data Dn corresponding to panel characteristics of the liquid crystal panel 2 as individual pieces of data. The panel characteristics include gamma characteristics and omega characteristics. The gamma characteristics indicate a relationship between the gray levels and brightness (or optical transmittance). The omega characteristics indicate a center voltage deviation caused by a parasitic capacitance Cgd during the alternate driving. The positive grayscale data Dp and the negative grayscale data Dn for correcting the gamma characteristics and the omega characteristics are in the positive internal LUT 52A and the negative internal LUT 52B. The gamma characteristics indicate a relationship between the gray levels and brightness (or optical transmittance). The omega characteristics indicate a center voltage deviation caused by a parasitic capacitance Cgd during the parallel driving.

As illustrated in FIG. 4, the positive grayscale data Dp and the negative grayscale data Dn do not indicate the same value for the specific input grayscale data (gray level). Namely, the voltage difference between the positive grayscale voltage VH and the common electrode voltage Vcom is different from the voltage difference between the negative grayscale voltage VL for the same gray level and the common electrode voltage Vcom. As illustrated in FIG. 5, the relationship between the gray levels and the grayscale voltages (source driver output voltages) on the positive side and that on the negative side are asymmetric about the common electrode voltage Vcom. In FIG. 5, a solid line curve indicates the relationship between the input gray levels and the output voltages (grayscale voltages) based on the data in the LUTs 52A and 52B corresponding to the panel characteristics of the liquid crystal panel 2. A broken line curve indicates the relationship between the input gray levels and the grayscale voltages corresponding to the characteristics of the source driver 3 that is currently used. The solid line curve and the broken line curve may change according to the characteristics of the liquid crystal panel 2 and the characteristics of the source driver 3, respectively.

The common electrode voltage Vcom is originally set to the center voltage of the alternate driving. However, the common voltage drifts from the common electrode voltage Vcom due to the omega characteristics. When the common voltage drift occurs, a DC component remains during the alternate driving, which results in deterioration of liquid crystals. In this embodiment, the common electrode voltage Vcom is maintained at constant and the common voltage drift is corrected (omega correction). For the omega correction, the positive grayscale data Dp and the negative grayscale data Dn are set according to the input gray levels (data). As described above, the data prepared in consideration of the gamma correction and omega correction are included in the LUTs 52A and 52B. The data in the LUTs 52A and 52B (see FIG. 4) correspond to the solid line curve in FIG. 5.

If the input gray level is “500,” the positive grayscale voltage VH for the input gray level of 500 corresponds to the positive grayscale voltage VH670 for the input gray level “670” according to the characteristics of the source driver 3. The negative grayscale voltage VL for the input gray level of “330” corresponds to the negative grayscale voltage VL330. As illustrated in FIG. 4, if the input gray level is “500,” the positive grayscale data Dp “2680” is related to the positive grayscale voltage VH 670, and the negative grayscale data Dn “1320” is related to the negative grayscale voltage VL330. When the DA converter 32A receives the positive grayscale signal SDp containing the positive grayscale data Dp “2680,” the DA converter 32A selects the positive grayscale voltage VH670. If the DA converter 32A receives the negative grayscale data Dn containing “1320,” the DA converter 32A selects the negative grayscale voltage VL330.

Specifically, when creating the data in LUT 52A and 52B, a specific grayscale voltage to be output corresponding to the specific gray level may not be among the output grayscale voltages that can be output by the source driver 3. In such a case, the output grayscale voltage close to the specific grayscale voltage is selected. If the input gray level is “500,” a desired level of the positive grayscale voltage VH is not necessarily matched with a level of the positive grayscale voltage VH670 for the input gray level “670.”

The digital gamma omega corrector 51 receives an image signal containing the grayscale data and creates the positive grayscale signal SDp for positive driving and the negative grayscale signal SDn for negative driving with reference to the LUTs 52A and 52B, respectively, according to the polarity inversion signal REV.

Specifically, as illustrated in FIG. 4, the digital gamma omega corrector 51 reads out the positive grayscale data Dp and the negative grayscale data Dn with reference to the positive internal LUT 52A and the negative internal LUT 52B based on the 10-bit grayscale data (input gray levels) included in the image signal. The digital gamma omega corrector 51 generates the 12-bit positive grayscale signal SDp and the 12-bit negative grayscale signal SDp based on the read positive grayscale data Dp and the read negative grayscale data Dn according to the polarity inversion signal REV.

The positive grayscale signal SDp and the negative grayscale signal SDn are input to the dither processor 54 and a dither process such as a frame rate control (FRC) is performed. The processed signals are input to the source driver 3.

In this embodiment, the data is written in the LUTs 52A and 52B via a ROM or an EEPROM. By altering the data in the ROM or the EEPROM to be written to the LUTs 52A and 52B, panel driving corresponding to the characteristics of the panel characteristics of the liquid crystal panel 2 can be performed. The LUTs 52A and 52B may not be arranged inside the timing controller 5 and may be arranged in specific areas of the ROM or the EEPROM of the memory 6. In this case, the digital gamma omega corrector 51 refers to the positive grayscale data Dp and the negative grayscale data On and directly reads them out of the memory 6. The data written in the LUTs 52A and 52B are determined based on the characteristics of the liquid crystal panel 2 in advance achieved by experiments.

If the liquid crystal panel 2 is a color liquid crystal panel, the LUTs 52A and 52B are prepared for RGB signals. The grayscale signals SDp and SDn corresponding to the RGB signals are generated. Namely, the grayscale signals SDp and SDn are generated for an input R (red) grayscale data, for an input G (green) grayscale data, and for an input B (blue) grayscale data, respectively.

In this embodiment, only four kinds of reference voltages are applied to the source driver 3, the positive maximum voltage VHmax, the positive minimum voltage VHmin, the negative maximum voltage VLmax, and the negative minimum voltage VLmin. The reference voltages are for generating the positive grayscale voltages VH for positive driving and the negative grayscale voltages VL for negative driving. For driving the liquid crystal panel 2 with the AC voltage at multiple gray levels, the grayscale voltages are generated based on the four kinds of reference voltages and the resistance voltage divider circuit 31A and 31B of the source driver 3.

The grayscale voltages are generated according to the characteristics of the liquid crystal panel, for instance, the gamma characteristics or the omega characteristics. Specifically, the grayscale voltages are created based on the data in the LUTs 52A and 52B for correcting the gamma characteristics or the omega characteristics. During driving of the liquid crystal panel 2 with positive and negative polarities at multiple gray levels, the kinds of the reference voltages applied to the source driver 3 to create the grayscale voltages can be reduced. A grayscale DAC for creating the grayscale voltages according to the characteristics of the liquid crystal panel may not be required. Furthermore, only the limited kinds of reference voltages or grayscale voltages to transmit from the liquid crystal control unit 4 to the source driver 3 are required. Therefore, the number of connector pins can be reduced. Namely, the configuration for creating the grayscale voltages according to the characteristics of the liquid crystal panel can be simplified.

### Other embodiments

The present invention is not limited to the embodiment illustrated in the above description and the drawings. For example, the following embodiments may be included in the technical scope of the present invention.

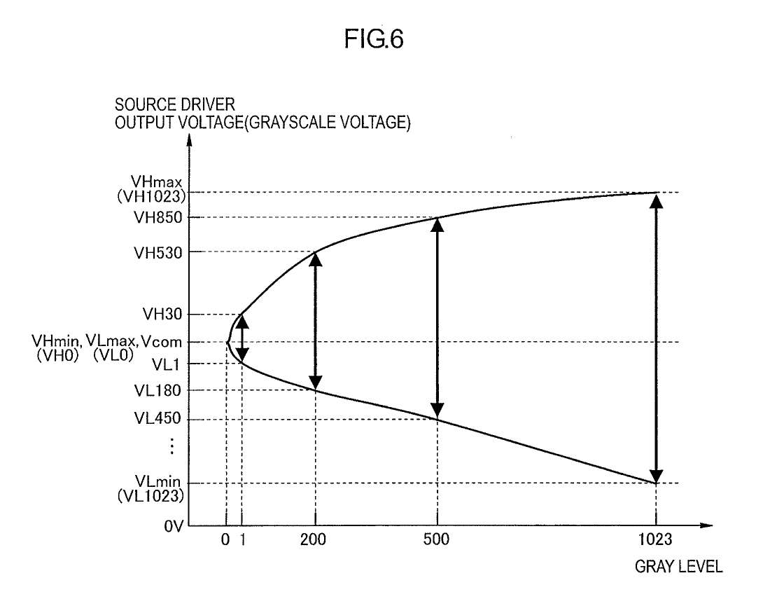

(1) In the above embodiment, the minimum voltage VHmin (VH0) among the positive grayscale voltages VH and the maximum voltage VLmax (VL0) among the negative grayscale voltages VL are set different levels. However, the minimum voltage VHmin and the maximum voltage VLmax may be set at the same level. As illustrated in FIG. 6, the minimum voltage VHmin (VH0) and the maximum voltage VLmax (VL0) may be set to the common electrode voltage Vcom. In this case, the kinds of voltages generated by the voltage generator 7 are reduced. Therefore, a degree of complexity in configuration of the voltage generator 7 can be reduced and the number of lines between the voltage generator 7 and the source driver 3 can be reduced.

(2) In the above embodiments, the timing controller (the grayscale signal generator) includes the digital gamma omega corrector 51 to generate the grayscale signals SDp and SDn with the gamma correction and the omega correction. However, the timing controller 5 may be configured differently. For example, the timing controller 5 (the grayscale signal generator) may be configured to generate grayscale signals SDp and SDn only with the gamma correction. In this case, the positive grayscale data Dp and the negative grayscale data Dn only with the gamma correction may be set in the LUTs 52A and 52B. With this configuration, the gamma correction according to the gamma characteristics of the liquid crystal panel 2 still can be easily performed by altering the data in the LUTs 52A and 52B.

(3) In the above embodiments, the common electrode voltage is applied to the common electrode and the common electrode voltage is set to the center voltage of the AC driving voltage. However, the scope of the present invention can be applied to any liquid crystal panels driven with positive and negative polarities.

(4) In the above embodiments, the maximum voltage VHmax among the positive grayscale voltages VH and the minimum voltage VLmin among the negative grayscale voltages VL are fixed voltages. However, the voltages (VHmax, VHmin, Vlmax, VLmin) can be varied according to liquid crystal panels. Namely, the voltage generator 7 may be configured to vary the maximum voltages VHmax and VLmax and the minimum voltages VHmin and VLmin. In this case, the data in the LUTs 52A and 52B may be set according to the voltages (VHmax, VHmin, VLmax, VLmin).

### EXPLANATION OF SYMBOLS

2: Liquid crystal panel

3: Source driver

4: Liquid crystal control unit

5: Timing controller

6: Memory

7: Voltage generator

10: Liquid crystal display device

31A, 31B: Ladder resistor

51: Digital gamma omega corrector

51A: Positive internal LUT

51B: Negative internal LUT

1. A liquid crystal control device comprising:
a liquid crystal panel configured to be alternately driven with positive polarity and negative polarity;
a liquid crystal driver including resistance voltage divider circuit and configured to generate a plurality of grayscale voltages and to alternately drive the liquid crystal panel with positive polarity and negative polarity;
a grayscale signal generator configured to
receive an image signal containing grayscale data,
generate a positive grayscale signal and a negative grayscale signal separately from each other according to characteristics of the liquid crystal panel, the positive grayscale signal being for driving the liquid crystal panel with positive polarity, the negative grayscale signal being for negative driving the liquid crystal panel with negative polarity, and
supply the positive grayscale signal and the negative grayscale signal to the liquid crystal driver; and
a voltage generator configured to
generate positive maximum and minimum voltages for generating grayscale voltages to drive the liquid crystal panel with positive polarity, according to the positive grayscale signal,
generate negative maximum and minimum voltages for generating grayscale voltages to drive the liquid crystal panel with negative polarity, according to the negative grayscale signal, and
apply the generated voltages to the liquid crystal driver.

2. The liquid crystal control device according to claim 1, wherein
the grayscale signal generator includes
a positive lookup table configured to store positive grayscale data for generating the positive grayscale signal corresponding to the grayscale data, and
a negative lookup table configured to store negative grayscale data for generating the negative grayscale signal corresponding to the grayscale data, and
the grayscale signal generator is configured to generate the positive grayscale signal and the negative grayscale signal using the positive lookup table and the negative lookup table.

3. The liquid crystal control device according to claim 2, wherein the positive lookup table and the negative lookup table include positive grayscale data and negative grayscale data, respectively, the positive grayscale data and the negative grayscale data being prepared according to panel characteristics of the liquid crystal panel.

4. The liquid crystal control device according to claim 2, further comprising an electrically rewritable memory, wherein the positive lookup table and the negative lookup table are stored in the memory.

5. The liquid crystal control device according to claim 1, wherein the voltage generator is configured to generate positive minimum voltage and the negative maximum voltage of at a same voltage level.

6. The liquid crystal control device according to claim 5, wherein
the liquid crystal panel includes a common electrode for driving the liquid crystals, and
the voltage generator is configured to generate a common electrode voltage applied to the common electrode of the liquid crystal panel, and to generate the positive minimum voltage and the negative maximum voltage at a same voltage level as the common electrode voltage.

7. A liquid crystal panel driving device configured to alternately drive a liquid crystal panel with positive polarity and with negative polarity, the liquid crystal panel driving device comprising:
a grayscale signal generator configured to
receive an image signal containing grayscale data, and
generate a positive grayscale signal and a negative grayscale signal separately from each other according to characteristics of the liquid crystal panel, the positive grayscale signal being for driving the liquid crystal panel with positive polarity, the negative grayscale signal being for driving the liquid crystal panel with negative polarity;
a voltage generator configured to
generate maximum and minimum voltages for driving the liquid crystal panel with positive polarity, and
generate maximum and minimum voltages for driving the liquid crystal panel with negative polarity; and
a liquid crystal driver including a resistance voltage divider circuit, the liquid crystal driver being configured to
generate a positive grayscale voltage corresponding to the positive grayscale signal using the resistance voltage divider circuit and the maximum voltage and the minimum voltage for driving the liquid crystal panel with positive polarity,
generate a negative grayscale voltage corresponding to the negative grayscale signal using the resistance voltage divider circuit and the maximum voltage and the minimum voltage for driving the liquid crystal panel with negative polarity, and
alternately apply the positive grayscale voltage and the negative grayscale voltage to the liquid crystal panel every predetermined period.

8. The liquid crystal panel driving device according to claim 7, wherein
the grayscale signal generator includes
a positive lookup table configured to store positive grayscale data for generating the positive grayscale signal corresponding to the grayscale data, and
a negative lookup table configured to store negative grayscale data for generating the negative grayscale signal corresponding to the grayscale date, and
the grayscale signal generator is configured to generate the positive grayscale signal and the negative grayscale signal using the positive lookup table and the negative lookup table, respectively.

9. The liquid crystal panel driving device according to claim 8, wherein the positive lookup table and the negative lookup table contains positive grayscale data and negative grayscale data, respectively, the positive lookup table and the negative lookup table being prepared according to panel characteristics of the liquid crystal panel, respectively.

10. The liquid crystal panel driving device according to claim 8, further comprising an electrically rewritable memory, wherein the positive lookup table and the negative lookup table are stored in the memory.

11. The liquid crystal panel driving device according to claim 7, wherein the voltage generator is configured to generate the positive minimum voltage and the negative maximum voltage at a same voltage level.

12. The liquid crystal panel driving device according to claim 11, wherein
the liquid crystal panel includes a common electrode for driving liquid crystals, and
the voltage generator is configured to
generate a common electrode voltage applied to the common electrode, and
generate the positive minimum voltage and the negative maximum voltage at a same voltage level as the common electrode voltage.

13. A liquid crystal display device comprising:
a liquid crystal panel; and
a liquid crystal panel driving device according to claim 7.

14. A method of driving a liquid crystal panel with positive polarity and negative polarity through a liquid crystal driver including a resistance voltage divider circuit, the method comprising:
receiving an image signal containing grayscale data;
generating a positive grayscale signal and a negative grayscale signal separately from each other according to characteristics of the liquid crystal panel;
supplying the positive grayscale signal and the negative grayscale signal to the liquid crystal driver;
generating positive maximum and minimum voltages according to the positive grayscale signal;
generating negative maximum and minimum voltages;
applying the positive maximum voltage, the positive minimum voltage, the negative maximum voltage, and the negative minimum voltage to the liquid crystal driver;
generating positive grayscale voltages corresponding to the positive grayscale signal by dividing a voltage difference between the positive maximum voltage and the positive minimum voltage with the resistance voltage divider circuit of the liquid crystal circuit, the positive grayscale voltages being generated to drive the liquid crystal panel with positive polarity;
generating negative grayscale voltages corresponding to the negative grayscale signal by diving a voltage difference between the negative maximum voltage and the negative minimum voltage with the resistance voltage divider circuit of the liquid crystal driver, the negative grayscale voltages being generated to drive the liquid crystal panel with negative polarity.

15. The method according to claim 14, further comprising including positive grayscale data in a positive lookup table and negative grayscale data in a negative lookup table, wherein the positive grayscale signal and negative grayscale signal generating step includes generating the positive grayscale signal with reference to the positive grayscale data in the positive lookup table, and generating the negative grayscale signal with reference to the negative grayscale data in the negative lookup table.

16. The method according to claim 15, further comprising storing the positive lookup table and the negative lookup table in an electrically rewritable memory, wherein
the positive grayscale data including step includes preparing the positive grayscale data according to panel characteristics of the liquid crystal panel, and
the negative grayscale data including step includes preparing the negative grayscale data according to the panel characteristics of the liquid crystal panel.
